(19) United States
(12) Patent Application Publication
(10) Pub. No.: US 2012/0070802 A1
(43) Pub. Date: Mar. 22, 2012

(54) Dental implant fabrication and insertion methods and personalized dental implant for use therein

(76) Inventor: Herbert S. Woodward, III, Vista, CA (US)

(21) Appl. No.: 12/807,995

(22) Filed: Sep. 17, 2010

(51) Int. Cl. A61C 8/00; G06F 19/00

(52) U.S. Cl. 433/175; 433/173; 700/98

(57) ABSTRACT

Dental implant fabrication and insertion methods and a personalized dental implant for use in such methods. Such a personalized dental implant is prefabricated by a computer-operated milling machine using a computer model generated using digital images taken of a dental patient's natural tooth in situ. After the natural tooth is extracted from the dental patient's mouth, the personalized dental implant is immediately inserted into the socket created by the extraction. Insertion of this dental implant immediately after the extraction obviates the need for multiple oral surgeries, avoids delicate structures, and is less invasive. Moreover, since this dental implant is custom fitted for the socket, osseointegration is expedited and the risk of bone collapse is reduced.

### BACKGROUND OF THE INVENTION

The present invention relates to dentistry and, more particularly, to dental implant fabrication and insertion methods and a personalized dental implant for use in such methods.

When a tooth is extracted from a dental patient's mouth, an empty socket is created in the patient's mouth at the extraction site. This socket must be filled to prevent bone from collapsing and maintain bone dimension and contours at the affected region of the patient's mouth.

One approach to filling the socket is to insert bone grafting material into the socket immediately after the extraction, if there is no infection. Then, after a healing period that permits initial osseointegration to occur, a screw-type dental implant is affixed at the extraction site. Unfortunately, this approach requires months of time and multiple oral surgeries—a first one to perform the extraction and grafting and a second one to seat the dental implant—over a span of weeks or even months. Moreover, there is a risk with this approach of bone collapse before osseointegration of the implant can occur.

Another approach to filling the socket is to insert an off-the-shelf artificial dental implant into the socket immediately after the extraction, again with bone grafting material used to fill in the voids. Unfortunately, since the artificial dental implant is not custom fitted for the socket, it typically fails to make intimate contact with all of the surfaces of the socket and relies on frictional fit to establish initial stability. This contact failure can lead to an extended osseointegration period for stability and, in the worst case, osseointegration failure and bone collapse. Another complication that arises with off-the-shelf dental implants is that special care must be taken to avoid delicate structures, like sinuses, nerves and blood vessels.

### SUMMARY OF THE INVENTION

The present invention provides a dental implant fabrication and insertion methods and a personalized dental implant for use in such methods. Such a personalized dental implant is prefabricated by a computer-operated milling machine using a computer model generated using digital images taken of a dental patient's natural tooth in situ. After the natural tooth is extracted from the dental patient's mouth, the personalized dental implant is immediately inserted into the socket created by the extraction. Insertion of this dental implant immediately after the extraction obviates the need for multiple oral surgeries, avoids delicate structures, and is less invasive. Moreover, since this dental implant is custom fitted for the socket, osseointegration is expedited and the risk of bone collapse is reduced.

In one aspect of the invention, a dental implant fabrication method comprises the steps of receiving data for one or more digital images depicting a natural tooth; generating, using the digital image data, a computer model of a dental implant; and fabricating, using the computer model, the dental implant.

In some embodiments, the digital implant has a root structure that is an analogue of the root structure of the natural tooth.

In some embodiments, the fabrication method further comprises the step of modifying the digital image data from a modeling station based on user input.

In some embodiments, the digital images are cone beam computed tomography (CBCT) scan images.

In some embodiments, the digital image data are embodied in a Digital Imaging and Communications in Medicine (DICOM) file.

In some embodiments, the computer model is embodied in a stereolithography (STL) file.

In some embodiments, the dental implant is fabricated from a titanium blank.

In some embodiments, the dental implant is fabricated from an integrated titanium/porcelain blank.

In some embodiments, the digital implant has a titanium root structure.

In some embodiments, the digital implant has a titanium crown preparation.

In some embodiments, the digital implant has a porcelain crown.

In another aspect of the invention, a dental implant insertion method comprises the steps of extracting a natural tooth from a patient; and inserting, into a socket created by the extraction, a dental implant fabricated prior to the extraction by a computer-controlled milling machine using a computer model generated using data from one or more digital images depicting the natural tooth.

In some embodiments, the digital implant has a root structure that is an analogue of the root structure of the natural tooth.

In some embodiments, the insertion method further comprises the step of applying a first stabilizing agent between the dental implant and the socket.

In some embodiments, the first stabilizing agent is hydroxyapatite (HA) cement.

In some embodiments, the insertion method further comprises the step of applying a second stabilizing agent between the dental implant and an adjacent tooth.

In some embodiments, the second stabilizing agent is a composite.

In some embodiments, the extraction is non-traumatic.

In yet another aspect of the invention, a dental implant comprises an upper structure; and a root structure coupled with the upper structure, wherein the dental implant is fabricated by a computer-controlled milling machine using a computer model generated using data from one or more digital images depicting a natural tooth.

In some embodiments, the root structure is an analogue of a root structure of the natural tooth.

In some embodiments, the digital image data are modified based on user input.

In some embodiments, the root structure is made of titanium.

In some embodiments, the upper structure comprises a titanium crown preparation.

In some embodiments, the upper structure comprises a porcelain crown.

In yet another aspect of the invention, a dental implant fabrication system, comprises a modeling station adapted to generate, using data from one or more digital images depicting a natural tooth taken by a digital imaging device, a computer model of a dental implant; and a computer-operated milling machine adapted to fabricate, using the computer model, the dental implant.

In some embodiments, the dental implant has a root structure that is an analogue of the root structure of the natural tooth.

In some embodiments, the modeling station is further adapted to modify the digital image data based on user input.

In some embodiments, the digital images are CBCT scan images.

In some embodiments, the digital image data are embodied in a DICOM file.

In some embodiments, the computer model is embodied in an STL file.

In some embodiments, the digital imaging device is a computed tomography (CT) scanner.

In some embodiments, the digital imaging device is a CBCT scanner.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a personalized dental implant fabrication system in some embodiments of the invention.

FIG. 2 shows a CBCT scan image.

FIG. 3 is a rendering of a personalized dental implant as shown on a display screen.

FIG. 4A shows a titanium blank from which a crown prep type personalized dental implant is fabricated.

FIG. 4B shows integral titanium/porcelain blank from which a tooth type personalized dental implant is fabricated.

FIG. 5A shows a crown prep type personalized dental implant.

FIG. 5B shows a tooth type personalized dental implant.

FIG. 6 shows a personalized dental implant insertion procedure in some embodiments of the invention.

FIG. 7 shows a personalized dental implant after placement in some embodiments of the invention.

FIG. 8 describes a personalized dental implant fabrication and insertion method in some embodiments of the invention.

### DETAILED DESCRIPTION OF A PREFERRED EMBODIMENT

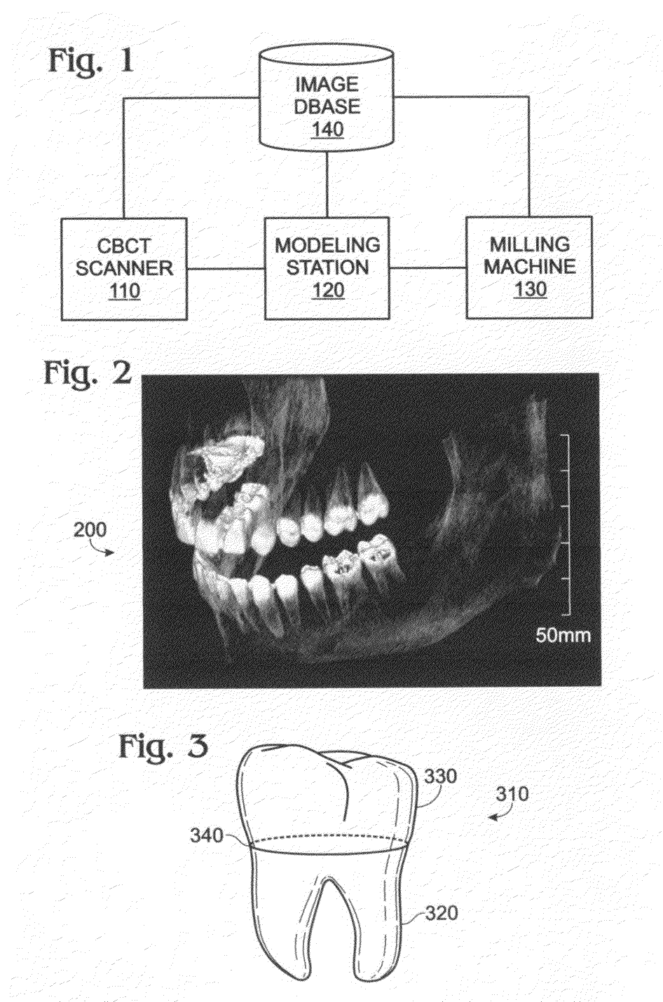

FIG. 1 shows a personalized dental implant fabrication system in some embodiments of the invention. The system includes a CBCT scanner 110, a modeling station 120 and a milling machine 130, which are communicatively coupled with an image database 140. Modeling station 120 is also directly communicatively coupled with CBCT scanner 110 and with milling machine 130.

CBCT scanner 110 is a digital imaging device that takes CBCT scan images of a proposed implant site of a dental patient, including images of a natural tooth in situ that is to be extracted, and surrounding bone and tissue. The natural tooth may include a root and crown, or just a root. FIG. 2 shows an exemplary CBCT scan image 200. CBCT scanner 110 creates a DICOM file that includes a digital representation of the CBCT scan images taken from the dental patient. The DICOM file is exported to image database 140. CBCT scanner 110 may be located at a CT scan center, a dentist's office or another suitable location. Moreover, a digital imaging device other than a CBCT scanner may be used.

Modeling station 120, under the guidance of the dentist who will perform the extraction/implant surgery or another authorized user, generates a ready to manufacture (RTM) computer model of a personalized dental implant for the dental patient based on the CBCT scan image data embodied in the DICOM file stored in database 140. Modeling station 120 is a personal computer or workstation that executes computer-aided design (CAD) software and conversion software to convert DICOM files into stereolithography (STL) files under microprocessor control. Modeling station 120, under instruction from the dentist or other authorized user, accesses the DICOM file from database 140 and CBCT scan image data is rendered on a display screen of modeling station 120. The dentist or other authorized user modifies the CBCT scan image data using user interface tools provided by the CAD software. For example, the dentist or other authorized user may select a dental implant type, which may be a crown preparation type implant (root plus crown prep) or a tooth type implant (complete tooth). A crown prep type implant may be selected if it is desired to add a crown to the personalized dental implant after the implant surgery. Moreover, the dentist or other authorized user may make other selections and modifications that affect the personalized dental implant shape and crown color (if any) and the location of the interface line between the root and crown or crown prep in relation to the patient's crest of bone, adjacent teeth and tissue. Once the dentist or other authorized user is satisfied with the changes to the CBCT scan image data (after one or more modeling sessions), modeling station 120 generates from the modified CBCT scan image data a RTM model of a personalized dental implant having a root structure that is an analogue of the root structure of the in situ natural tooth depicted in the CBCT scan images, which is embodied in an STL file. The STL file embodying the RTM model is exported to database 140. A computer-controlled milling machine 130 is then invoked to fabricate the personalized dental implant based on the RTM model. Modeling station 120 may be located at a dentist's office, or at another suitable location.

In other embodiments, modifications are performed by the dentist or other authorized user on the RTM model of the personalized dental implant after DICOM-STL conversion.

FIG. 3 shows an exemplary rendering 310 of a personalized dental implant on a display screen of modeling station 120 using CAD software. Rendering 310 is shown in perspective view, but can be shown in other views and can be repositioned and reoriented on screen using user interface tools supported by the CAD software. Moreover, rendering 310 can be shown in relation to surrounding bone, teeth and tissue. Rendering 310 as shown is of a tooth type implant and has a root structure 320 coupled with a crown structure 330. An interface line 340 divides structures 320, 330. A dentist or other authorized user modifies rendering 310, including the implant shape, crown color and the location of interface line 340 using user interface tools supported by the CAD software to create a “virtual” personalized dental implant from which a RTM model and, ultimately, a physical specimen, can be generated.

Milling machine 130 fabricates the personalized dental implant based on the RIM model embodied in an STL file and stored in database 140. Milling machine 130 executes rapid prototyping software under microprocessor control. Upon command received from modeling station 120 or inputted directly on milling machine 130, milling machine 130 accesses the STL file from database 140 and generates a set of milling instructions that are executed sequentially on an suitable blank in a computer-controlled precision milling operation to produce a personalized dental implant having a root structure that is an analogue, or substantial replica, of the natural tooth root structure. Milling machine 130 is typically located at a manufacturing facility remote from the dentist's office, but may be on-site if the dentist's office is so equipped.

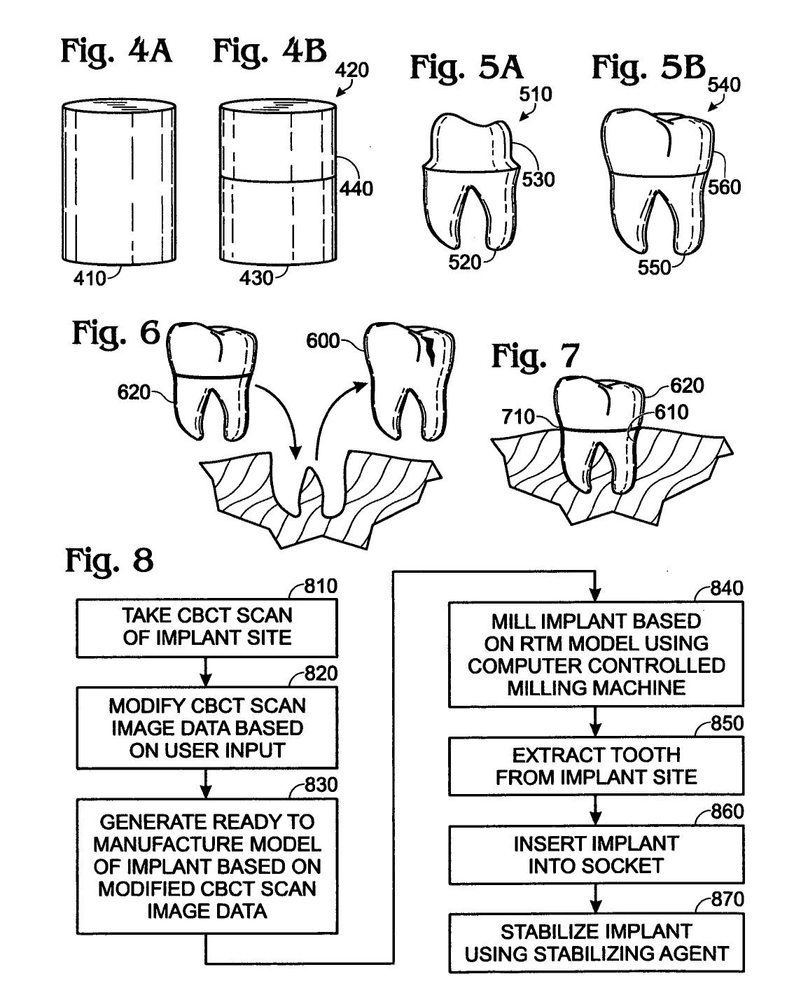

FIG. 4A shows an exemplary titanium blank 410 from which a crown prep type personalized dental implant is milled. Blank 410 is a cylinder of sufficient height and diameter to ensure that a complete crown prep type personalized dental implant can be ground therefrom. FIG. 5A shows an exemplary crown prep type personalized dental implant 510 ground from titanium blank 410 based on a RTM model embodied in an STL file. Implant 510 includes a titanium root structure 520 and crown prep 530 integrally formed from blank 410.

FIG. 4B shows integral titanium/porcelain blank 420 from which a tooth type personalized dental implant is milled. Blank 420 has a porcelain portion 440 and a titanium portion 430 that are fused together. Blank 420 is shown to be cylindrical and of sufficient height and diameter to ensure that a complete tooth type personalized dental implant can be ground therefrom, but may come in whatever shape the stock is manufactured. Moreover, porcelain portion 440 and titanium portion 430 are sized to ensure that the complete root and crown, respectively, of a tooth type personalized dental implant can be ground therefrom. FIG. 5B shows an exemplary tooth type personalized dental implant 540 ground from titanium/porcelain blank 420 based on a RTM model embodied in an STL file. Implant 540 includes a titanium root structure 550 formed from titanium portion 430 and porcelain crown 560 formed from porcelain portion 440, both of which are integrally formed from blank 420.

Once the personalized dental implant (e.g., 510, 540) has been fabricated, it is inspected for defects by manufacturing facility personnel. If the inspection is passed, the implant is sterilized, packaged and shipped (if necessary) to the dentist who will perform the implant surgery. Naturally, if the inspection is not passed, another copy may be fabricated using the processes described above.

FIG. 6 shows a personalized dental implant insertion procedure in some embodiments of the invention. Typically, the procedure takes place at the dentist's office at a scheduled appointment time. Before extracting the natural tooth 600, the personalized dental implant 620 is carefully unpacked and inspected by the dentist. If inspection is passed, natural tooth 600 is loosened and the personalized dental implant 620 is readied. Personalized dental implant 620 is then held in suspension above the extraction site. A rapid replacement operation is then executed by the dentist in which natural tooth 600 is extracted non-traumatically from extraction site, creating a socket 610, and personalized dental implant 620 is inserted immediately into socket 610. Socket 610 is vacant for no longer than a few seconds, preferably fewer than two, so that blood does not have a chance to fill socket 610.

FIG. 7 shows personalized dental implant 620 after placement in some embodiments of the invention. Due to careful digital image-based computer modeling and precision manufacturing, personalized dental implant 620 snugly fits within socket 610 and makes intimate contact with all surfaces of socket 610. Moreover, the interface line between the root structure and the crown of personalized dental implant 620 is symbiotic with the dental patient's bone and gum lines. The dentist may apply, if deemed necessary, HA cement 710 along the upper ridge of socket 610 to improve implant stabilization during osseointegration. Moreover, a stabilizing agent, such as a composite, may be applied to bond personalized dental implant 620 to one or more adjacent teeth for added stability, where indicated.

FIG. 8 describes a personalized dental implant fabrication and insertion method in some embodiments of the invention. A CBCT scanner 110 takes dental CBCT scans of the implant site (810), which are stored in database 140 as a DICOM file. The DICOM file is accessed from modeling station 120 by the dentist or another authorized user and the CBCT scan image data are manipulated in one or more modeling sessions conducted on modeling station 120 to create a virtual personalized dental implant that satisfies replacement requirements (820). When the changes are complete, the CBCT scan image data are converted into a RIM model that is embodied in an STL file (830), which is stored in database 140. Milling machine 130 is then invoked to grind the personalized dental implant from a blank based on the RTM model (840), after which the implant is inspected, sterilized, packaged and shipped to the dentist. After careful inspection, treatment plan and preparation of the personalized dental implant, the dentist performs a rapid replacement operation in which the natural tooth is non-traumatically extracted from the implant site (850) and the personalized dental implant is inserted into the socket left by the extraction (860). Finally, as part of the same procedure the dentist applies a stabilizing agent, such as HA cement, either to the whole implant site, or just the coronal portion along the upper ridge of the socket to stabilize the implant for a short period of time. A stabilizing agent, such as a composite, may also be applied between the personalized dental implant and one or more adjacent teeth (870).

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A dental implant fabrication method, comprising the steps of:
receiving data for one or more digital images depicting a natural tooth
generating, using the digital image data, a computer model of a dental implant; and
fabricating, using the computer model, the dental implant.

2. The fabrication method of claim 1, wherein the digital implant has a root structure that is an analogue of the root structure of the natural tooth.

3. The fabrication method of claim 1, further comprising the step of modifying the digital image data from a modeling station based on user input.

4. The fabrication method of claim 1, wherein the digital images are cone beam computed tomography (CBCT) scan images.

5. The fabrication method of claim 1, wherein the digital image data are embodied in a Digital Imaging and Communications in Medicine (DICOM) file.

6. The fabrication method of claim 1, wherein the computer model is embodied in a stereolithography (STL) file.

7. The fabrication method of claim 1, wherein the dental implant is fabricated from a titanium blank.

8. The fabrication method of claim 1, wherein the dental implant is fabricated from an integrated titanium/porcelain blank.

9. The fabrication method of claim 1, wherein the digital implant has a titanium root structure.

10. The fabrication method of claim 1, wherein the digital implant has a titanium crown preparation.

11. The fabrication method of claim 1, wherein the digital implant has a porcelain crown.

12. A dental implant insertion method, comprising the steps of:
extracting a natural tooth from a patient; and
inserting, into a socket created by the extraction, a dental implant fabricated prior to the extraction by a computer-controlled milling machine using a computer model generated using data from one or more digital images depicting the natural tooth.

13. The insertion method of claim 12, wherein the digital implant has a root structure that is an analogue of the root structure of the natural tooth.

14. The insertion method of claim 12, further comprising the step of applying a stabilizing agent between the dental implant and the socket.

15. The insertion method of claim 14, wherein the stabilizing agent is hydroxyapatite (HA) cement.

16. The insertion method of claim 12, wherein the insertion method further comprises the step of applying a stabilizing agent between the dental implant and an adjacent tooth.

17. The insertion method of claim 16, wherein the stabilizing agent is a composite.

18. The insertion method of claim 12, wherein the extraction is non-traumatic.

19. A dental implant, comprising:
an upper structure; and
a root structure coupled with the upper structure, wherein the dental implant is fabricated by a computer-controlled milling machine using a computer model generated using data from one or more digital images depicting a natural tooth.

20. The dental implant of claim 19, wherein the root structure is an analogue of a root structure of the natural tooth.

21. The dental implant of claim 19, wherein the digital image data are modified based on user input.

22. The dental implant of claim 19, wherein the root structure is made of titanium.

23. The dental implant of claim 19, wherein the upper structure comprises a titanium crown preparation.

24. The dental implant of claim 19, wherein the upper structure comprises a porcelain crown.

25. A dental implant fabrication system, comprising:
a modeling station adapted to generate, using data from one or more digital images depicting a natural tooth taken by a digital imaging device, a computer model of a dental implant; and
a computer-operated milling machine adapted to fabricate, using the computer model, the dental implant.

26. The fabrication system of claim 25, wherein the dental implant has a root structure that is an analogue of the root structure of the natural tooth.

27. The fabrication system of claim 25, wherein the modeling station is further adapted to modify the digital image data based on user input.

28. The fabrication system of claim 25, wherein the digital images are CBCT scan images.

29. The fabrication system of claim 25, wherein the digital image data are embodied in a DICOM file.

30. The fabrication system of claim 25, wherein the computer model is embodied in an STL file.

31. The fabrication system of claim 25, wherein the digital imaging device is a computed tomography (CT) scanner.

32. The fabrication system of claim 25, wherein the digital imaging device is a CBCT scanner.
